(19) United States
(12) Patent Application Publication
(10) Pub. No.: US 2014/0306518 A1
(43) Pub. Date: Oct. 16, 2014

(54) ELECTRICAL POWER/COMMUNICATION SYSTEM

(71) Applicant: TRYONIC LTD., London (GB)

(72) Inventors: Giuseppe Paronetto, Montebelluna (TV) (IT); Fabio Cappelli, Montebelluna (TV) (IT)

(73) Assignee: TRYONIC LTD., London (GB)

(21) Appl. No.: 14/348,488

(22) PCT Filed: Sep. 27, 2012
(86) PCT No.: PCT/IB2012/055165

§ 371 Date: Mar. 28, 2014

(30) Foreign Application Priority Data
Sep. 29, 2011 (IT) TV2011A000130

(51) Int. Cl. B62J 1/28; A41D 19/015; A41D 13/00; B62K 21/26

(52) U.S. Cl. CPC B62J 1/28; B62K 21/26; A41D 19/015; A41D 13/0002
USPC 307/9.1

(57) ABSTRACT

To improve the power or signal electrical transfer it is described a n electric power/communication system (10). It comprises a first contact surface (22, 24, 32, 34), adapted for being fed by a source (60) to transfer electrical power and/or signal, which is comprised on a surface in sight of a vehicle; and a garment (50) having a second outer contact surface (52, 54), adapted for conducting electric energy and/or receive electrical power and/or signal for a user device (70), which is configured to be able to touch the first contact surface in order to receive electrical power and/or signal.

The present invention relates to a system of electrical power/communication, in particular for vehicles.

We refer to the power supply as an example of objects and/or garments worn by a motorcyclist.

Systems are known in U.S. Pat. No. 7,905,620 or WO 03/058 763 wherein the onboard battery of the motorcycle or a portable battery in exploited for powering electrical devices separate from the vehicle and worn by the pilot.

The cable connections are undoubtedly uncomfortable, bind the freedom of movement of the driver and one loses time to engage insert the connectors. Often the connection operation is not easy or is laborious.

The battery systems however have the problem of low energy autonomy, and the power available is very limited.

The main object of the invention is to solve one of these problems, in particular the inconvenience of wiring and/or the limited autonomy.

These objects are achieved with a system according to claim 1, namely comprising

a first contact surface, preferably adapted to conduct electrical energy (current and/or voltage), adapted for being fed by a source to transfer electrical power and/or one or more signals, which is comprised on a surface in sight of a vehicle;

a garment (to be worn by a user of the vehicle) having a second outer contact surface, adapted for conducting electric energy (current and/or voltage) and/or receiving electrical power and/or one or more signals (e.g. alternate signals and/or processed by modulation) for a user device, which is configured to be able to touch the first contact surface in order to receive therefrom electrical power and/or signal.

As user device one can use or integrate any electronic device, both passive eg. Like a resistor, and active, i.e. that is able to perform intelligent functions and/or able to exchange said one or more signals to and from the vehicle via the two contact surfaces. E.g. as active device we cite one or more gyroscopes for directional control, a radio transmitter/receiver, e.g. according to the Bluetooth protocol, or an activator circuit of an airbag, or one or more microprocessors or logic circuits.

Preferably the garment comprises or is associated to a helmet. In this case one or more electronic devices can be electrically fed and/or connected with signal to the vehicle via the two surfaces. They can be devices that regulate or control features of the helmet, e.g. a motorized operator of the visor, or a display circuit on or in the visor adapted to generate images on the visor to be seen by the pilot, or a light intensity regulator circuit arranged on or in the visor adapted to control the transparency of the visor.

Preferably the system is comprised in a motorcycle, in which case the action of mounting astride can activate the electric contact between motorcycle and garment.

The power source may comprise a battery or alternator of the vehicle, e.g. advantageously the one already provided, and/or the source of electrical signal may comprise an electronic circuit in the vehicle (e.g. advantageously an instrument or accessory already fitted to the dashboard.

The garment may comprise a suit or motorcyclist gloves, which can easily contact the exposed surface of the motorbike to create electrical continuity.

The second contact surface may comprise areas or conductive regions or electrodes, made on the outer surface of the garment, which are mutually electrically isolated. Each area or zone functions as electrodes for one polarity of the signal or power supply.

The first contact surface may comprise conducting areas or electrodes, electrically insulated between each other, made superficially on a saddle or seat of the vehicle, or on the handlebar. In this way easy and natural electrical connection between the vehicle and garment when the user uses it is ensured.

To maximize the safety of the system it can comprise means for electrically disconnecting the first contact surface from the source as a function of the proximity of the garment.

The invention is also directed to a method, see claim 12. The method serves to electrically feed or to let communicate a user electrical device placed on or inside a garment from/with an electrical power source and/or signal placed on board a vehicle. According to the method

a first contact surface (22, 24) is configured in sight on the vehicle so that it can transfer electrical power and/or signal from the source,

a second external contact surface is configured on or in the garment (outer surface) so that it can by contact receive electrical power and/or one or more signals (e.g. alternate signals and/or processed by modulation) from the first contact surface.

The electrical power and/or signal(s) can then be transferred to the user device via known electrical wiring or other signal transmission techniques.

The invention is also generally directed to a garment. It can be powered by a power and/or signal source, and comprises two outer surface areas being conductive and isolated from each other, each area being adapted to pick up by contact, from the source, a polarity of the power or signal.

The invention is also directed to a vehicle in general, which comprises a power supply and/or signal source, characterized in that it comprises in sight two outer superficial areas being conductive and isolated from each other, which areas are (i) each adapted to provide a polarity of the power supply and/or signal, and (ii) integrated into, or forming part of, a seat or saddle or handlebar.

Note that all variants hereby for brevity defined and/or described only for one of the system, the method, the garment or the vehicle, are applicable mutatis mutandis to each.

The advantages of the invention will be more apparent from the following description of a preferred embodiment of the system, making reference to the attached drawing in which:

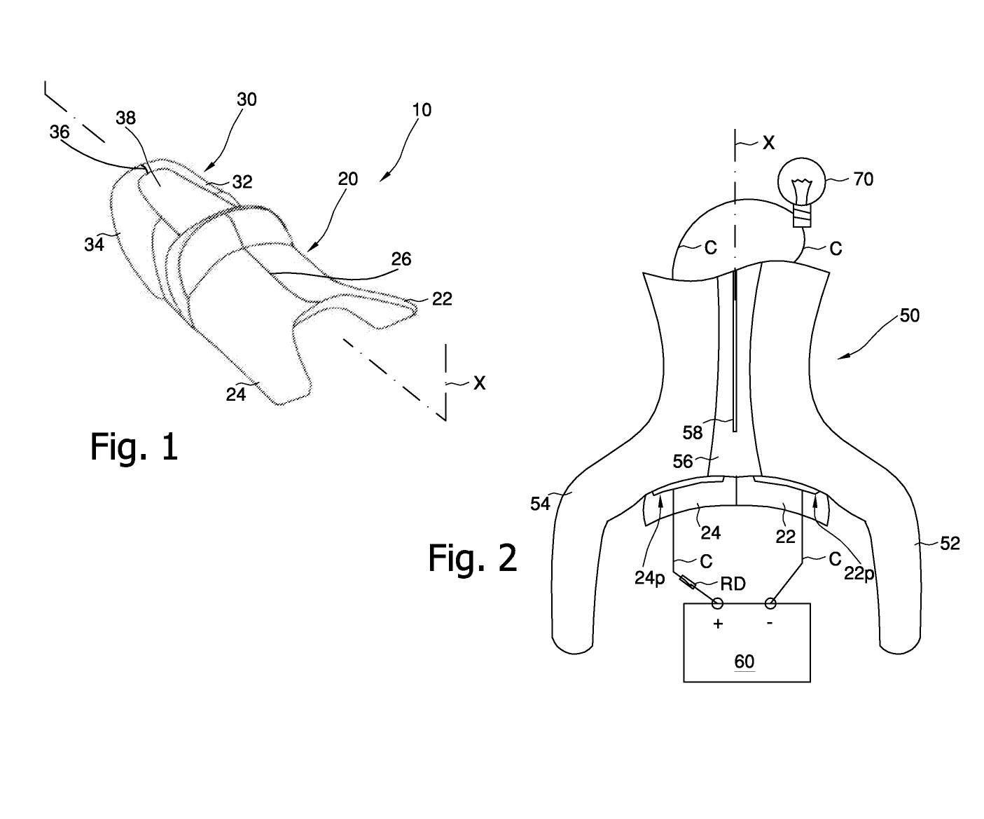

FIG. 1 shows a perspective view of a saddle according to the concept of the invention;

FIG. 2 shows a front view of the saddle with mounted above a pilot having a suit or garment according to the generic concept of the invention.

A saddle 10 of a motorcycle comprises two seats 20, 30 for two passengers. The two seats work electrically in equal ways, the saddle 10 being able to have even just one.

The seat 20 (30) comprises two areas or surface zones 22, 24 (32, 34) electrically isolated between each other (see midline of insulation 26 (36) and the neutral zone 38). The areas 22, 24 (32, 34) have surfaces in sight adapted to conduct an electric current and represent two electrodes which can be connected by surface contact. The areas 22, 24 (32, 34) are substantially arranged symmetrically relative to a plane of symmetry X of the saddle 10 (which divides it in half and passes through the lines 26 (36)).

The areas 22, 24 (32, 34) may include e.g. metal exposed plates, a metal grid or an array of areolas. As conductive metal e.g. copper or aluminum is preferred.

FIG. 2 shows the system in operation and indicates with references 22p, 24p some surface extended and conductive portions of areas 22, 24.

On the saddle 10 a user sits with a suit 50 designed to electrically mate by contact with the saddle 10. The suit 50 has correspondingly two surface conductive areas or zones 52, 54 which, by mounting on the saddle 10, touch the areas 22, 24 (the same can be true for the rear passenger and areas 32, 34). The areas 52, 54 are electrically insulated from each other by a central insulating strip 56 which divides symmetrically the suit 50 and houses a zip 58. The areas 52, 54 may include portions which cover the thighs and/or buttocks of the rider, so that it is enough to sit for establishing electrical contact.

In essence, the plane X of electric separation in the saddle 10 corresponds to that of the suit 50 when the pilot is mounted on the saddle. It follows that the areas 52, 54 overlap and touch respectively the areas 22, 24, and electrical continuity between the saddle 10 and suit 50 is established.

The areas 22, 24 are each electrically connected e.g. to a pole of a voltage source 60 (battery or alternator of the motorbike). The areas 52, 54 are each electrically connected e.g. to a pole of a user device 70 mounted on or in the suit 50. The connection can occur via conductors C or electrical conduction means internal to the suit 50 (not shown) or by directly extending the areas 52, 54 up to the user device 70.

The inventive principle may also be applied e.g. to gloves which contact conducting areas of the handlebar, knobs or control levers on the handlebars.

The appropriate size of the band 56 prevents accidental short-circuits. It can be possible—advantageously—to provide the system with a suitable electronic circuit (e.g. of known type), located on the vehicle and/or on the suit, adapted to prevent short-circuits or to make the system insensitive thereto and/or adapted to separate the component of electrical power from the signal component.

Optionally, with the advantage of zeroing the electric potential on the areas 22, 24 when the user is not on the saddle, in a conductor C a normally-open switch RD (e.g. a reed switch) can be inserted. By using a magnet on/in the suit 50 or a dedicated control on the vehicle (e.g. an activation button), one can switch on the switch RD when the user needs/wants to power the suit 50 from the vehicle.

1. Electric power/communication system comprising
a first contact surface, adapted for being fed by a source to transfer electrical power and/or signal, which is comprised on a surface in sight of a vehicle;
a garment having a second outer contact surface, adapted for conducting electric energy and/or receive electrical power and/or signal for a user device, which is configured to be able to touch the first contact surface in order to receive electrical power and/or signal.

2. System according to claim 1, comprised in a motorcycle.

3. System according to claim 1, wherein the power source comprises a battery or the vehicle alternator and/or the electrical signal source comprises an electronic circuit on-board the vehicle.

4. System according to claim 3, wherein the garment comprises a suit or gloves, for motorcycle or not.

5. System according to claim 4, wherein the second contact surface comprises conductive areas or electrodes obtained on the outer surface of the garment which are electrically isolated from each other.

6. System according to claim 4, wherein the first contact surface comprises conductive areas or electrodes, each electrically isolated from each other, obtained superficially on a saddle or seat of the vehicle.

7. System according to claim 4, comprising means for electrically disconnecting the first contact surface from the source as a function of the garment proximity.

8. System according to claim 4, wherein the user device comprises an electronic device able to perform intelligent functions and/or able to exchange said signal to and from the vehicle through said two contact surfaces.

9. System according to claim 8, wherein the user device comprises a radio transmitter/receiver or an activator circuit for an airbag or a microprocessor.

10. System according to claim 8, wherein the garment comprises or to the garment is associated a helmet comprising an electronic device that can be electrically powered and/or connected through the two surfaces.

11. System according to claim 10, wherein the electronic device in the helmet comprises a motorized operator for the visor, or a display circuit on or in the visor adapted to generate images on the visor to be seen by the pilot, or a light intensity regulator circuit arranged on or in the visor adapted to control the transparency of the visor.

12. Method for electrically powering/communicating with an electrical device, placed on or inside a garment, from a power and/or electrical signal source placed on-board a vehicle, wherein
configuring a first contact surface in sight on the vehicle so that it can transfer electrical power and/or signal from the source,
configuring a second external contact surface on or in the garment so that it can by contact receive electrical power and/or signal from the first contact surface.

13. Garment adapted to be fed by a power and/or signal source, wherein it comprises two outer surface areas being conductive and isolated from each other, each area being adapted to pick up by contact, from the source, a polarity of the power or signal.

14. Vehicle comprising a power supply and/or signal source, wherein it comprises in sight two outer superficial areas being conductive and isolated from each other, which areas are (i) each adapted to provide a polarity of the power supply and/or signal, and (ii) integrated into, or forming part of, a seat or saddle or handlebar.
